(19) United States
(12) Patent Application Publication
(10) Pub. No.: US 2025/0184063 A1
(43) Pub. Date: Jun. 5, 2025

(54) METHOD AND APPARATUS FOR PROCESSING DATA ASSOCIATED WITH A DEVICE

(71) Applicant: Robert Bosch GmbH, Stuttgart (DE)

(72) Inventors: Pedro Maia De Sant Ana, Stuttgart (DE); Nikolaj Marchenko, Waldenbuch (DE)

(21) Appl. No.: 18/947,560

(22) Filed: Nov. 14, 2024

(30) Foreign Application Priority Data
Dec. 4, 2023 (DE) 10 2023 212 148.4

(51) Int. Cl. H04L 5/00; H04W 72/54

(52) U.S. Cl. CPC H04L 5/0048; H04W 72/54

(57) ABSTRACT

A method for processing data associated with a device, wherein the device is configured to transmit, for example, multi-dimensional user data comprising semantic information via a communication system, comprising: provision of pilot data, wherein the pilot data is of the same type as the user data; transmission of the pilot data via the communication system.

### BACKGROUND

The disclosure relates to a method for processing data associated with a device.

The disclosure further relates to an apparatus for processing data associated with a device.

### SUMMARY

Some examples relate to a method, for example a computer-implemented method, for processing data associated with a device, wherein the device is configured to transmit, for example, multi-dimensional user data comprising semantic information via a communication system comprising, for example, at least one wireless data transmission link, comprising: provision of pilot data, wherein the pilot data is of the same type as the user data; transmission of the pilot data via the communication system. In some examples, this enables the evaluation and/or adjustment of properties, e.g. parameters, of the communication system with regard to the pilot data.

In some examples, the pilot data is designed to enable an assessment of the transmission quality via the communication system with regard to the semantic information, for example based on an evaluation of the received pilot data.

In some examples, it is provided that the user data characterizes and/or comprises at least one of the following elements: a) image data, or b) video data, or c) LIDAR data. Without limiting the generality, reference is made below mainly by way of example to user data and pilot data in the form of image data. For example, the pilot data may be pilot images, such as digital images with a matrix-like organization of image elements and at least one intensity or color channel.

Other data types, such as multidimensional data, are also conceivable in other examples.

In some examples, the device is designed to be at least one of the following elements: a) a robot, or b) a technical system, for example an automated system, for example a cyber-physical system, or c) a manufacturing device, or d) an autonomous transport system, wherein, for example, the device or at least one component of the device is designed to be mobile.

In some examples, it is envisaged that the method comprises: Transmission of initial information characterizing a use of the pilot data, for example to a network device associated with the communication system. This allows the network device to be informed, for example, about how the device uses pilot data or which pilot data should be used.

In some examples, it is envisaged that the initial information comprises at least one of the following elements: a) at least part of the pilot data, for example pilot images, or b) information on which pilot data is to be used (e.g. using a reference to pilot data known to both the device and the network device, e.g. storable in a database), or c) (e.g. future) changes regarding pilot data to be used.

In some examples, it is envisaged that the method comprises: Receiving of instructions regarding the pilot data, for example from a network device associated with the communication system, and, optionally, influencing the provision and/or transmission of the pilot data based on the instructions.

In some examples, it is envisaged that the method comprises: Transmitting of information characterizing at least one requirement (e.g. minimum required accuracy, e.g. F1-score of an image recognition) regarding the pilot data, for example to a network device associated with the communication system.

Some examples relate to a method, for example a computer-implemented method, for processing data associated with a device, wherein the device is designed to receive, for example, multi-dimensional user data comprising semantic information via a communication system, for example having at least one wireless data transmission link, for example from another device, for example the device described above according to the disclosure, comprising: Receiving of pilot data transmitted via the communication system, wherein the pilot data is of the same type as the user data, transmission of a feedback regarding the received pilot data, for example to a network device associated with the communication system.

In some examples, the feedback is designed to include at least one of the following elements: a) an accuracy with respect to an evaluation, for example detection, of the received pilot data, or b) information associated with an evaluation of the received pilot data, for example classification information. Thus, in some examples, the device receiving the pilot data may determine or generate said feedback, for example based on an evaluation of the received pilot data.

In some examples, it is envisaged that the method comprises: receiving of information characterizing a configuration of the pilot data and, optionally, using of the information characterizing the configuration of the pilot data, e.g., for receiving and/or evaluating the pilot data.

Some examples relate to a method, for example a computer-implemented method, for processing data associated with a network device for a communication system, comprising: receiving of initial information from a device that is designed to transmit, for example, multi-dimensional user data and pilot data comprising semantic information via the communication system (for example the pilot data sending device as described above according to the disclosure), wherein the initial information characterizes a use of the pilot data, wherein the pilot data is of the same type as the user data, optionally receiving information characterizing at least one requirement (e.g., on the part of the pilot data sending device) with regard to the pilot data, and allocating of resources for the pilot data based on at least one of the first pieces of information or the information characterizing the at least one requirement with respect to the pilot data.

In some examples, it is envisaged that the method comprises: Receiving, by a device which is designed to receive at least pilot data via the communication system, of a feedback regarding the received pilot data, optionally evaluating of the feedback, optionally the changing of at least one parameter of the communication system based on the feedback or based on the evaluation.

In some examples, the evaluation of the feedback is designed to comprise at least one of the following elements: a) creating statistics, b) determining whether at least one parameter of the communication system is to be changed, for example a modulation and coding scheme, MCS, and/or an MIMO, multiple input multiple output, configuration.

Further examples relate to an apparatus for carrying out the method according to the disclosure.

Further examples relate to a device comprising at least one apparatus according to the disclosure.

Further examples relate to a system comprising at least one device according to the disclosure and/or at least one apparatus according to the disclosure.

Further examples relate to a computer-readable storage medium comprising commands that, when executed by a computer, prompt the latter to perform the method according to the disclosure.

Further examples relate to a computer program comprising commands that, when the program is executed by a computer, cause the computer to carry out the method.

Further examples relate to a data carrier signal that transmits and/or characterizes the computer program according to the disclosure.

Further examples relate to a use of the method according to the disclosure and/or the apparatus according to the disclosure and/or the device according to the disclosure and/or the system according to the disclosure and/or the computer-readable storage medium according to the disclosure and/or the computer program according to the disclosure and/or the data carrier signal according to the disclosure for at least one of the following elements: a) adjusting at least one parameter of the communication system, b) providing an application-oriented transmission, e.g. for the user data, c) increasing an efficiency of a transmission, e.g. of the user data.

Further features, possible applications, and advantages of the invention emerge from the following description of examples of the invention, which are shown in the figures of the drawings. All described or depicted features by themselves or in any combination constitute the subject matter of the invention, regardless of their combination in the claims or their reference to other claims and regardless of their wording or representation in the description or in the drawings.

### BRIEF DESCRIPTION OF THE DRAWINGS

In the drawings:

FIG. 1 a schematic illustration of a simplified flowchart,

FIG. 2 a schematic illustration of a simplified block diagram,

FIG. 3 a schematic illustration of a simplified flowchart,

FIG. 4 a schematic illustration of a simplified flowchart,

FIG. 5 a schematic illustration of a simplified flowchart,

FIG. 6 a schematic illustration of a simplified flowchart,

FIG. 7 a schematic illustration of a simplified flowchart,

FIG. 8 a schematic illustration of a simplified flowchart,

FIG. 9 a schematic illustration of a simplified flowchart,

FIG. 10 a schematic illustration of a simplified block diagram,

FIG. 11 a schematic illustration of a simplified block diagram,

FIG. 12 a schematic illustration of a simplified block diagram,

FIG. 13 a schematic illustration of a simplified block diagram,

FIG. 14 a schematic illustration of aspects of uses.

### DETAILED DESCRIPTION

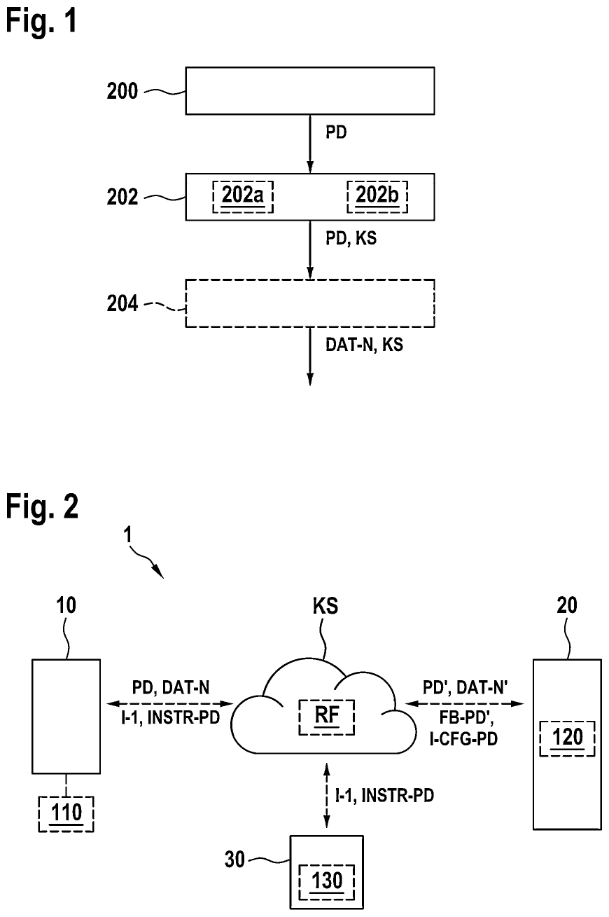

Some examples, FIG. 1, 2, relate to a method, for example a computer-implemented method, for processing data associated with a device 10 (FIG. 2), wherein the device 10 is configured to transmit, for example, multi-dimensional user data DAT-N comprising semantic information via a communication system KS comprising, for example, at least one wireless data transmission link RF, comprising: Provision of 200 (FIG. 1) pilot data PD, wherein the pilot data PD is of the same type as the user data DAT-N, transmission of 202 of the pilot data PD via the communication system KS, e.g. repeated transmission 202a, e.g. periodic transmission 202b. In some examples, this enables the evaluation and/or adjustment of properties, e.g. parameters, of the communication system KS with regard to the pilot data PD. The optional block 204 symbolizes a transmission of the DAT-N user data via the KS communication system.

In some examples, the user data DAT-N and/or pilot data PD transmitted by the device 10 are received, see for example the reference numerals DAT-N′, PD′. Depending on the transmission quality, the received data DAT-N′, PD′ may differ more or less from the transmitted data DAT-N, PD.

In some examples, the pilot data PD is designed to enable an assessment of the transmission quality via the communication system KS with regard to the semantic information, for example based on an evaluation of the received pilot data PD.

In some examples, it is provided that the user data DAT-N characterizes and/or comprises at least one of the following elements: a) image data, or b) video data, or c) LIDAR data. Without limiting the generality, reference is made below mainly by way of example to user data and pilot data in the form of image data. For example, the pilot data PD may be pilot images, such as digital images with a matrix-like organization of image elements and at least one intensity or color channel.

Other data types, such as multidimensional data, are also conceivable in other examples.

In some examples, FIG. 2, the device 10 is designed to be at least one of the following elements: a) a robot, or b) a technical system, for example an automated system, for example a cyber-physical system, or c) a manufacturing device, or d) an autonomous transport system, wherein, for example, the device or at least one component of the device is designed to be mobile. The same applies to the other device 20 in some examples.

By way of example, both devices 10, 20 are designed as robots which, for example, exchange image data with each other, both as user data DAT-N and as pilot data PD.

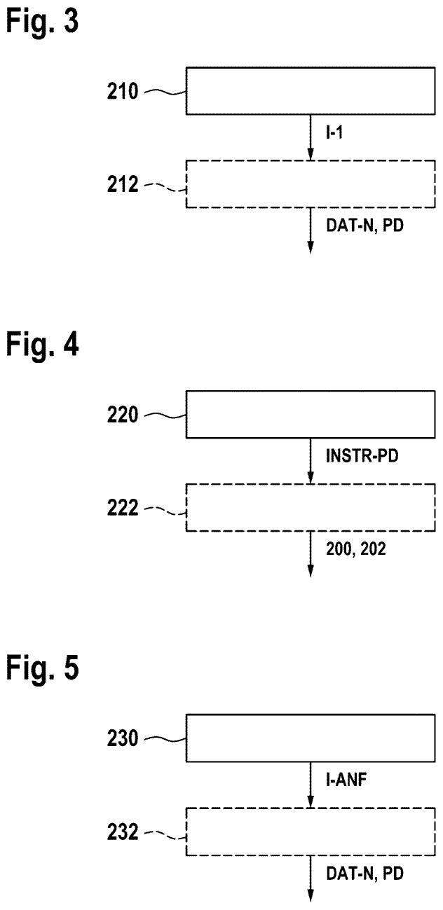

In some examples, FIG. 3, it is envisaged that the method comprises: Transmission 210 of initial information I-1 characterizing a use of the pilot data PD, for example to a network device 30 associated with the communication system KS (FIG. 2). This allows the network device to be informed, for example, about how the device 10 uses the pilot data PD or which pilot data should be used.

In some examples, it is envisaged that the initial information I-1 comprises at least one of the following elements: a) at least part of the pilot data PD, for example pilot images, or b) information on which pilot data is to be used (e.g. using a reference to pilot data known to both the device 10 and the network device 30, e.g. storable in a database), or c) (e.g. future) changes regarding pilot data to be used. The optional block 212 of FIG. 3 symbolizes a transmission of the user data DAT-N or pilot data PD, e.g. according to the initial information I-1.

In some examples, FIG. 4, it is envisaged that the method comprises: Receiving of 220 instructions INSTR-PD regarding the pilot data, for example from the network device 30, and, optionally, influencing 222 the provision 200 and/or transmission 202 of the pilot data PD based on the instructions. In some examples, the INSTR-PD instructions specify when or which pilot data, e.g. from the device 10, is to be used, e.g. sent, or which resources of the communication system (e.g. time/frequency resources) are to be used for transmitting 202 the pilot data PD.

In some examples, FIG. 5, it is envisaged that the method comprises: Transmitting 230 of information I-ANF characterizing at least one requirement (e.g. minimum required accuracy, e.g. F1-score of an image recognition) regarding the pilot data PD, for example to a network device 30 associated with the communication system. In some examples, the network device 30 may, for example, determine the instructions INSTR-PD (see block 220 of FIG. 4) based at least on the information I-ANF, e.g. forming. The optional block 232 according to FIG. 5 symbolizes an optional transmission of the user data DAT-N and/or pilot data PD.

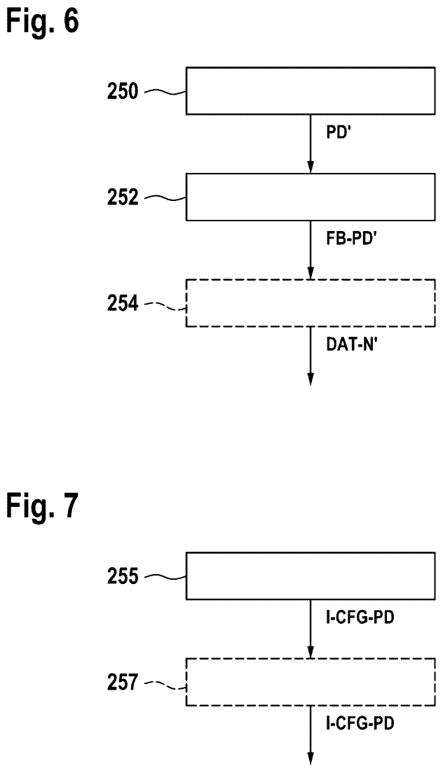

Some examples, FIG. 6, relate to a method, for example a computer-implemented method, for processing data associated with a device 20, wherein the device 20 (FIG. 2) is designed to receive, for example, multi-dimensional user data DAT-N comprising semantic information via a communication system KS, for example having at least one wireless data transmission link RF, for example from another device, for example the device 10 described above according to the disclosure, comprising: Receiving 250 (FIG. 6) of pilot data transmitted via the communication system KS, wherein the pilot data PD is of the same type as the user data DAT-N′, transmission 252 of a feedback FB-PD′ regarding the received pilot data PD, for example to a network device 30 associated with the communication system.

In some examples, the feedback FB-PD′ is designed to include at least one of the following elements: a) an accuracy with respect to an evaluation, for example detection, of the received pilot data PD′, or b) information associated with an evaluation of the received pilot data PD′, for example classification information. Thus, in some examples, the device 20 receiving the pilot data PD′ may determine or generate said feedback FB-PD′, for example based on an evaluation of the received pilot data PD′. The optional block 254 according to FIG. 6 symbolizes the receipt of user data DAT-N′.

In some examples, FIG. 7, it is envisaged that the method comprises: receiving 255 of information I-CFG-PD characterizing a configuration of the pilot data PD and, optionally, using 257 of the information I-CFG-PD characterizing the configuration of the pilot data PD, e.g., for receiving 250 and/or evaluating the pilot data PD′.

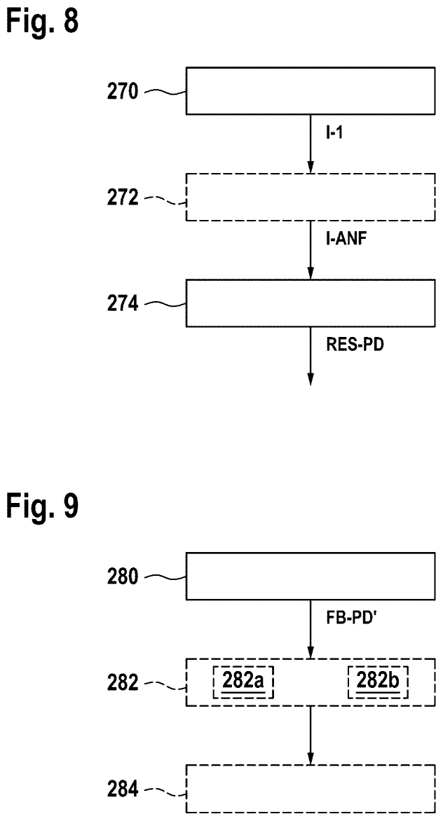

Some examples, FIG. 8, relate to a method, for example a computer-implemented method, for processing data associated with a network device 30 (FIG. 2) for a communication system KS, comprising: receiving 270 of initial information I-1 from a device 10 that is designed to transmit, for example, multi-dimensional user data DAT-N and pilot data PD comprising semantic information via the communication system KS (for example the pilot data sending device 10 as described above according to the disclosure), wherein the initial information I-1 characterizes a use of the pilot data, wherein the pilot data PD is of the same type as the user data DAT-N, optionally receiving 272 of information I-ANF characterizing at least one requirement (e.g., on the part of the pilot data sending device 10) with regard to the pilot data PD, and allocating 274 of resources RES-PD (e.g. time/frequency resources of the communication system KS) for the pilot data PD based on at least one of the first pieces of information I-1 or the information I-ANF characterizing the at least one requirement with respect to the pilot data PD.

In some examples, FIG. 9, it is envisaged that the method comprises: Receiving 280, by a device 20 which is designed to receive at least pilot data PD′ via the communication system KS, of a feedback FB-PD′ regarding the received pilot data PD′, optionally evaluating 282 of the feedback FB-PD′, optionally the changing 284 of at least one parameter of the communication system KS based on the feedback FB-PD′ or based on the evaluation 282. By way of example, the change 284 may also have: Requesting the device 10 to send more or less pilot data PD or to change a frequency for transmitting the pilot data PD.

In some examples, FIG. 9, the evaluation 282 of the feedback FB-PD′ is designed to comprise at least one of the following elements: a) creating 232a statistics, b) determining 282b whether at least one parameter of the communication system KS is to be changed, for example a modulation and coding scheme, MCS, and/or an MIMO, multiple input multiple output, configuration.

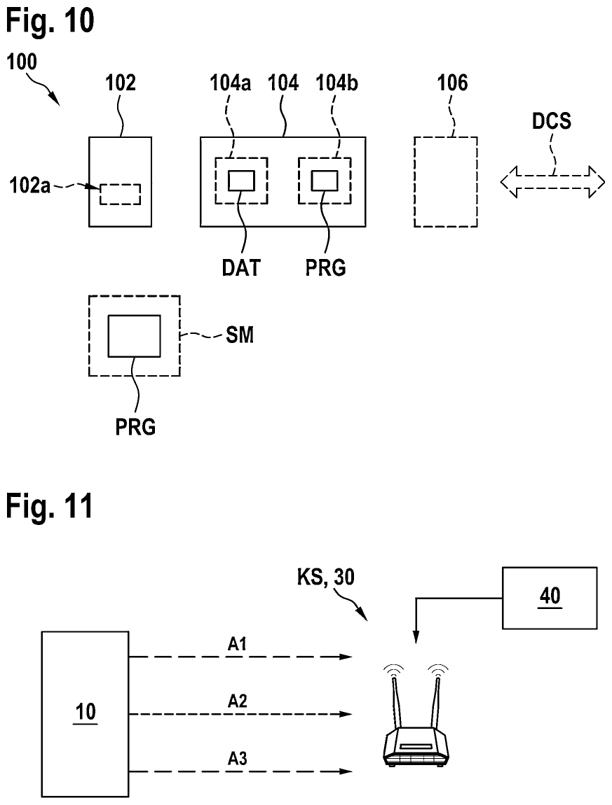

Further examples, FIG. 10, relate to an apparatus 100 for carrying out the method according to the disclosure. As an example, the apparatus can be assigned to the device 10 (FIG. 2), s. Block 110 from FIG. 2. As an example, the apparatus can be assigned to the device 20 (FIG. 2), s. Block 120 from FIG. 2. As an example, the apparatus can be assigned to the network device 30 (FIG. 2), s. Block 130 from FIG. 2. For example, the apparatus 110, 120, 130 may be integrated into the respective device 10, 20, 30 (or arranged outside the respective device 10, 20, 30).

By way of example, the apparatus 100, 110, 120, 130 may perform at least one, for example all, aspects of the method according to the disclosure.

By way of example, the apparatus 110 may perform aspects of the method according to the disclosure that relate to the device 10, see for example the diagrams of FIGS. 1, 3, 4, 5. By way of example, the apparatus 110 may also perform aspects of the method according to the disclosure that relate to the device 20, see for example the diagrams of FIGS. 6, 7.

By way of example, the apparatus 120 may perform aspects of the method according to the disclosure that relate to the device 20, see for example the diagrams of FIGS. 6, 7. By way of example, the apparatus 120 may also perform aspects of the method according to the disclosure that relate to the device 10, see for example the diagrams of FIGS. 1, 3, 4, 5.

By way of example, the apparatus 130 may perform aspects of the method according to the disclosure that relate to the network device 30, see for example the diagrams of FIGS. 8, 9.

In some examples, FIG. 10, it is envisaged that the apparatus 100 comprises: a computing device (“computer”) 102 having at least one computing core 102a, a storage device 104 associated with the computing device 102 for at least temporary storage of at least one of the following elements: a) data DAT (e.g. user data DAT-N, DAT-N′ or pilot data PD, PD′ or with other information I-1, I-ANF, I-CFG-PD, . . . associated data according to the disclosure), b) computer program PRG, for example for carrying out the method according to the disclosure.

In some examples, the storage device 104 comprises a volatile memory (e.g., random access memory (RAM)) 104a and/or a non-volatile (NVM) memory (for example, flash EEPROM) 104b, or a combination thereof, or other types of memory not explicitly mentioned.

Further examples relate to a computer-readable storage medium SM comprising commands PRG that, when executed by a computer 102, prompt the latter to perform the method according to the disclosure.

Further examples relate to a computer program PRG comprising commands that, when the program PRG is executed by a computer, cause the computer 102 to carry out the method.

Further examples refer to a data carrier signal DCS that characterizes and/or transmits the computer program PRG. For example, the data carrier signal DCS can be exchanged (received and/or transmitted) via an optional data interface 106 of the apparatus 100.

Further examples, FIG. 2, relate to a device 10, 20 or network device 30 with at least one apparatus 100, 110, 120, 130 according to the disclosure.

Further examples, FIG. 2, relate to a system 1 comprising at least one apparatus 100, 110, 120, 130 according to the disclosure and/or at least one device 10, 20, 30 according to the disclosure. Optionally, the system 1 can also have at least one network device 30.

For example, the communication system KS is designed as a wireless, for example cellular, mobile radio system, for example based on and/or compatible with a 4G and/or 5G and/or 6G standard.

For example, the network device 30 is a base station, e.g. gNB, of the communication system KS or is integrated into such a base station, e.g. gNB.

Further aspects and examples are described below, which—in the case of further examples—can each be combined individually or in any combination with one another with at least one of the aspects and/or examples described above.

FIG. 11 schematically shows a simplified block diagram according to some examples, which is associated, for example, with a phase of a definition of the pilot data. The arrows A1, A2, A3 symbolize aspects of the initial information I-1.

Arrow A1 symbolizes the transmitting of at least a part of the pilot data PD, for example pilot images, e.g. in the form of the initial information I-1, to the network device 30, e.g. such pilot data, e.g. pilot images, which are to be used from now on. For example, in some examples, a pilot data specification may be based on at least one of the following elements: a) relevance (index), b) categories, c) statistical analysis, etc.

Arrow A2 symbolizes transmitting information to the network device 30 indicating that the device 10 or an application associated with the device 10 will not send pilot data as initial information I-1, wherein, for example, predetermined pilot data known to multiple devices 10, 20, 30, e.g. pilot images, e.g. retrievable from a database 40, can be used.

Arrow A3 symbolizes a dynamic (during operation of the device 10) executable selection of pilot data and signaling of the selection, e.g. to the network device 30.

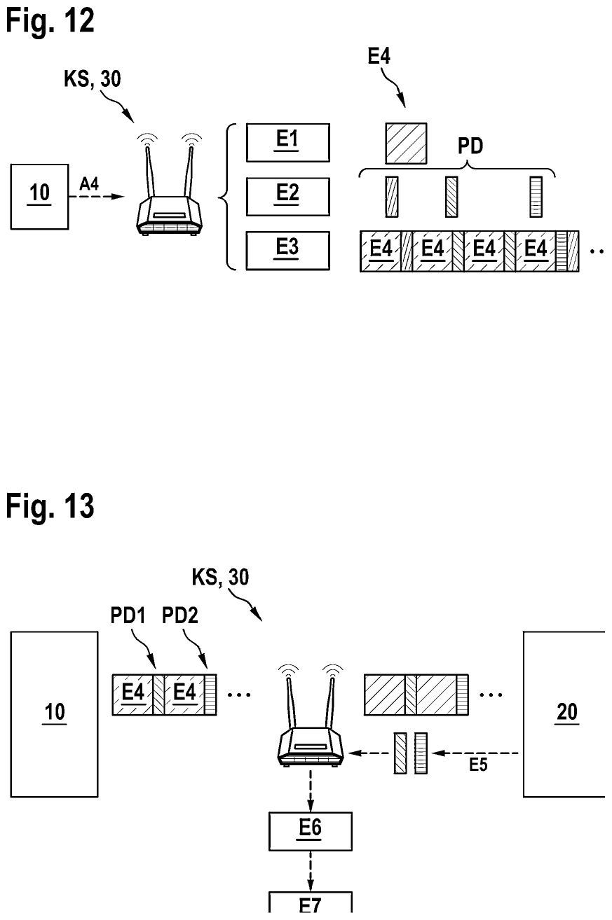

FIG. 12 schematically shows a simplified block diagram according to some examples, which is associated, for example, with a phase of an assignment with regard to the pilot data. The device 10 informs the network device 30 of its requirements, arrow A4, see e.g. also the element I-ANF according to FIG. 8. Based on this, network device 30 may include pilot data PD or Associate resources of the KS communication system for the pilot data with PD, e.g. with respect to at least one of the aspects a) frequency (e.g. frequency) E1, or b) sequence (sequence which pilot data follows other pilot data) E2, c) distribution E3 of the pilot data. Element E4 in FIG. 12 symbolizes user data as an example, and element PD in FIG. 12 symbolizes the various pilot data.

FIG. 13 schematically shows a simplified block diagram according to some examples, which is associated, for example, with a phase of a transmission of user data E4 and pilot data PD1, PD2, . . . . Element E5 symbolizes a feedback from the device 20 to the network device 30, e.g. about a quality of the pilot data received by the device 20. Based on the feedback E5, the network device 30 may, for example, adjust at least one parameter of the communication system KS, e.g. an MCS, and/or request the device 10 to change its transmission of pilot data PD (e.g. regarding frequency and/or type).

Element E6 symbolizes an evaluation of the feedback E5 by the network device, and element E7 symbolizes a change to the parameters and/or configuration of the communication system KS that may be made on the basis of the evaluation e6.

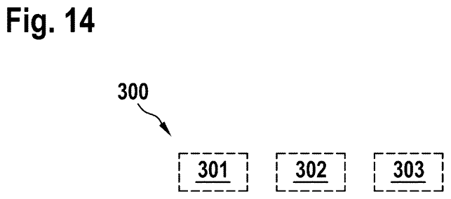

Further examples, FIG. 14, relate to a use 300 of the method according to the disclosure and/or the apparatus 100, 110, 120, 130 according to the disclosure and/or the device 10, 20, 30 according to the disclosure and/or the system 1 according to the disclosure and/or the computer-readable storage medium SM according to the disclosure and/or the computer program PRG according to the disclosure and/or the data carrier signal DCS according to the disclosure for at least one of the following elements: a) adapting 301 at least one parameter (e.g. MCS or MIMO configuration) of the communication system KS, b) providing 302 an application-oriented transmission (e.g. for an application associated with the robot 10, 20), e.g. for the user data, c) increasing 303 an efficiency of a transmission, e.g. of the user data.

In some examples, the principle according to the disclosure may be used for robots 10, 20 that exchange, for example, multi-dimensional data such as image data or LIDAR data or the like. In some examples, the use of pilot data of the same type as the user data advantageously enables a flexible evaluation and adaptation of the data transmission via a disturbed channel, such as a radio channel RF, taking into account a possible impairment of the semantic information contained in the user data or the pilot data. For example, an impaired transmission of image data (e.g., comprising camera images of information such as handwritten digits) from the robot 10 to the robot 20 may be tolerated as long as sufficient semantic information can thereby be transmitted from the robot 10 to the robot 20 (e.g., to enable correct recognition of the digits at the robot 20). In some examples, parameters e.g. of the communication system KS such as an MCS are only adapted (e.g. selection of a more robust MCS) to possible interference when the robot 20 no longer receives a sufficient amount of intact or correctly decodable semantic information from the robot 10 (e.g. the images with the digits contain so much noise that the robot 20 can no longer reliably recognize the digits). In some examples, this can be determined efficiently using the pilot data PD, e.g. pilot images.

In some examples, the principle according to the disclosure may be used, for example, for aspects of IoT or IIOT, and/or Industry 4.0.

In some examples, the principle according to the disclosure may, for example, help to avoid overprovisioning (e.g. keeping “too many” resources, for many practical cases), and/or to avoid exchanging information regarding a latency.

1. A computer-implemented method for processing data associated with a device (10), wherein the device (10) is configured to transmit multi-dimensional user data (DAT-N) that includes semantic information via a communication system (KS) that includes at least one wireless data transmission link (RF), the method comprising:
provision (200) of pilot data (PD), wherein the pilot data (PD) is of the same type as the user data (DAT-N), and
transmission (202) of the pilot data (PD) via the communication system (KS).

2. The method according to claim 1, wherein the pilot data (PD) is configured to enable an evaluation of a transmission quality via the communication system (KS) with regard to the semantic information.

3. The method according to claim 1, wherein the user data (DAT-N) comprises a) image data, or b) video data, or c) LIDAR data.

4. The method according to claim 1, wherein the device (10) is at least one selected from the group consisting of: a) a robot, b) a cyber-physical system, c) a manufacturing device, and d) an autonomous transport system, wherein the device (10) or at least one component of the device (10) is designed to be mobile.

5. The method according to claim 1, further comprising: transmission (210) of initial information (I-1) characterizing a use of the pilot data (PD) to a network device (30) associated with the communication system (KS).

6. The method according to claim 5, wherein the initial information comprises at least one of the following elements: a) at least part of the pilot data (PD), or b) information as to which pilot data (PD) is to be used, or c) changes regarding the pilot data (PD) to be used.

7. The method according to claim 1, further comprising: receiving (220) instructions (INSTR-PD) regarding the pilot data (PD) from a network device (30) associated with the communication system (KS), and influencing (222) the provision (200) and/or transmission (202) of the pilot data (PD) based on the instructions (INSTR-PD).

8. The method according to claim 1, further comprising: transmission (230) of information (I-ANF) that characterizes at least one request regarding the pilot data (PD), for example to a network device (30) associated with the communication system (KS).

9. A computer-implemented method, for processing data associated with a device (20), wherein the device (20) is configured to receive multi-dimensional user data (DAT-N′) that includes semantic information via a communication system (KS) that includes at least one wireless data transmission link (RF), the method comprising: receiving (250) of pilot data (PD′) transmitted via a communication system (KS), wherein the pilot data (PD′) is of the same type as the user data (DAT-N′), and transmission of (252) a feedback (FB-PD′) regarding the received pilot data (PD′) to a network device (30) associated with the communication system (KS).

10. The method according to claim 9, wherein the feedback (FB-PD′) comprises at least one of the following elements: a) an accuracy with respect to an evaluation or b) information associated with an evaluation of the received pilot data (PD′).

11. The method according to claim 9, further comprising: receiving (255) of information (I-CFG-PD) characterizing a configuration of the pilot data (PD, PD′), and using (257) of the information (I-CFG-PD) characterizing the configuration of the pilot data (PD, PD′).

12. A computer-implemented method for processing data associated with a network device (30) for a communication system (KS), the method comprising:
receiving (270) initial information (I-1) from a device (10) that is configured to transmit multi-dimensional user data (DAT-N) and pilot data (PD) that includes semantic information via the communication system (KS), wherein the initial information (I-1) characterizes a use of the pilot data (PD), wherein the pilot data (PD) is of the same type as the user data (DAT-N), receiving (272) information (I-ANF) characterizing at least one requirement with regard to the pilot data (PD), and
allocating (274) of resources (RES-PD) for the pilot data (PD) based on at least one of the first pieces of information (I-1) or the information (I-ANF) characterizing the at least one requirement with respect to the pilot data (PD).

13. The method according to claim 12, further comprising: receiving (280), by a device (20) which is configured to receive at least pilot data (PD′) via the communication system (KS), of a feedback (FB-PD′) regarding the received pilot data (PD′), evaluating (282) the feedback (FB-PD′), and the changing (284) at least one parameter of the communication system (KS) based on the feedback (FB-PD′) or based on the evaluation (282).

14. The method according to claim 13, wherein the evaluation (282) of the feedback (FB-PD′) comprises at least one of the following elements: a) creating (282a) statistics, b) determining (282b) whether at least one parameter of the communication system (KS) is to be changed, and/or an multiple input multiple output configuration.

15. An apparatus (100; 110; 120; 130) for processing data associated with a device (10), wherein the device (10) is configured to transmit multi-dimensional user data (DAT-N) that includes semantic information via a communication system (KS) that includes at least one wireless data transmission link (RF), where in the device is configured to:
provide (200) pilot data (PD), wherein the pilot data (PD) is of the same type as the user data (DAT-N), and
transmit (202) the pilot data (PD) via the communication system (KS).
